(19) United States
(12) Patent Application Publication
(10) Pub. No.: US 2005/0047154 A1
(43) Pub. Date: Mar. 3, 2005

(54) Illuminating device on wheels

(76) Inventor: Jen-Show Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/646,861

(22) Filed: Aug. 25, 2003

(51) Int. Cl. B62J 6/00

(52) U.S. Cl. 362/473

(57) ABSTRACT

An illuminating device includes a casing rotatably mounted to a wheel axle and a plurality of luminous elements are connected to the casing. A coil assembly is engaged with the casing and electrically connected to the luminous elements by wires. A collar has a circular magnet and the coil assembly rotatably encloses the circular magnet.

### FIELD OF THE INVENTION

The present invention relates to an illuminating device attached on bicycle wheels and includes a magnet which is rotatable relative to coil when the wheel is rotated so as to illuminate the light emitting diodes on the device.

### BACKGROUND OF THE INVENTION

A conventional illuminating device on bicycle wheels generally includes a battery and a lot of luminous elements such as bulbs or light emitting diodes which are powered by the battery so that when the wheel rotates, the bulbs or light emitting diodes illuminate and drivers can easily see the luminous wheels in the dark. Nevertheless, the battery occupies a lot of space and there is only limited space for the battery for a bicycle. Furthermore, the battery increases the total weight of the bicycle and that is not welcome by the cyclists.

The present invention intends to provide an illuminating device for bicycle wheel and is attached to the spokes of the wheel and occupies only a small space.

### SUMMARY OF THE INVENTION

In accordance with one aspect of the present invention, there is provided an illuminating device which is attached to spokes of a bicycle wheel and comprises a casing having a central hole for receiving a wheel axle therethrough and a plurality of luminous elements are connected to the casing. A coil assembly is engaged with the casing and wires extending from the coil assembly are electrically connected to the luminous elements. A collar is fixed connected to a front fork or chain stays and has an circular magnet. The coil assembly rotatably encloses the circular magnet.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show the illuminating device on a front wheel of a bicycle;

FIG. 2 is a front cross sectional view to show the illuminating device connected to spokes of the front wheel of a bicycle;

FIG. 3 is a front cross sectional view to show the illuminating device of the present invention;

FIG. 4 shows the illuminating device has a star-shaped casing;

FIG. 5 is a perspective view to show the illuminating device of the present invention;

FIG. 6 is an exploded view to show the illuminating device of the present invention;

FIG. 7 shows the wheel is not yet rotated and the luminous elements do not light up, and

FIG. 8 shows the wheel is rotated and the luminous elements light up.

### DETAILED DESCRIPTION OF THE PREFERRED EMBODIMENT

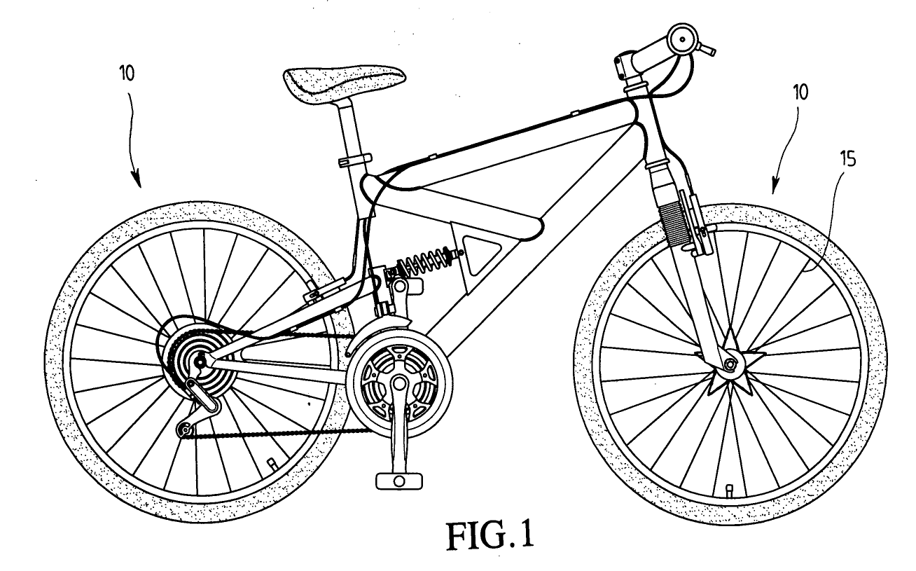

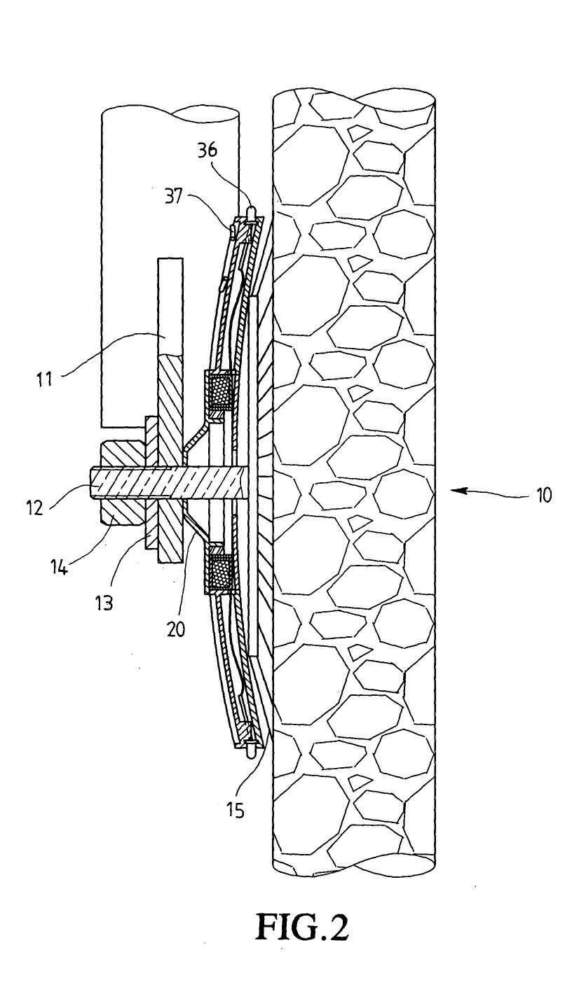

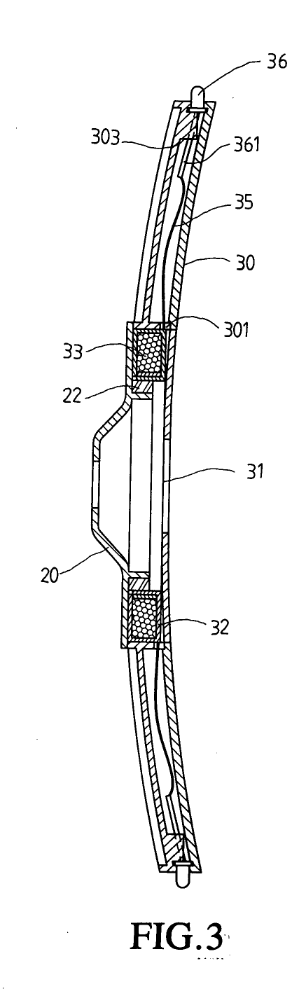

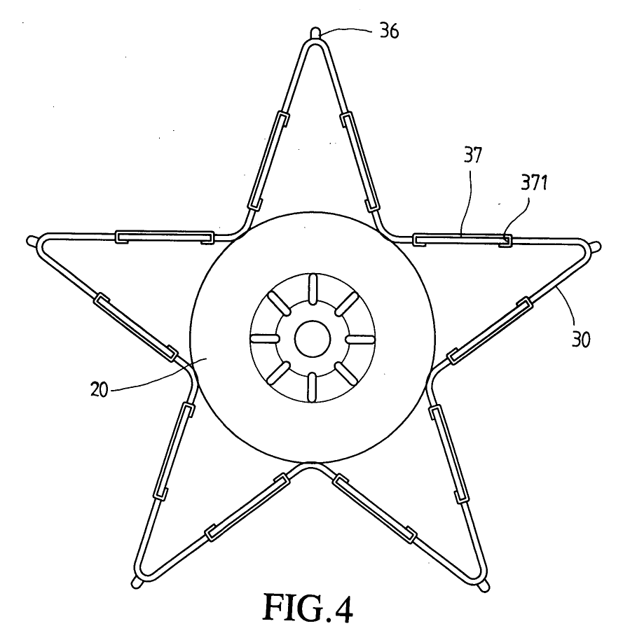

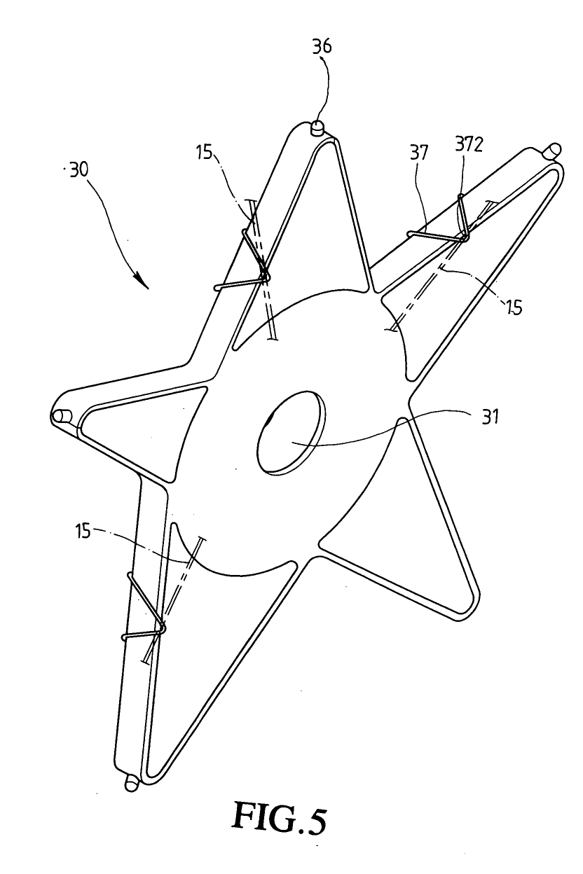

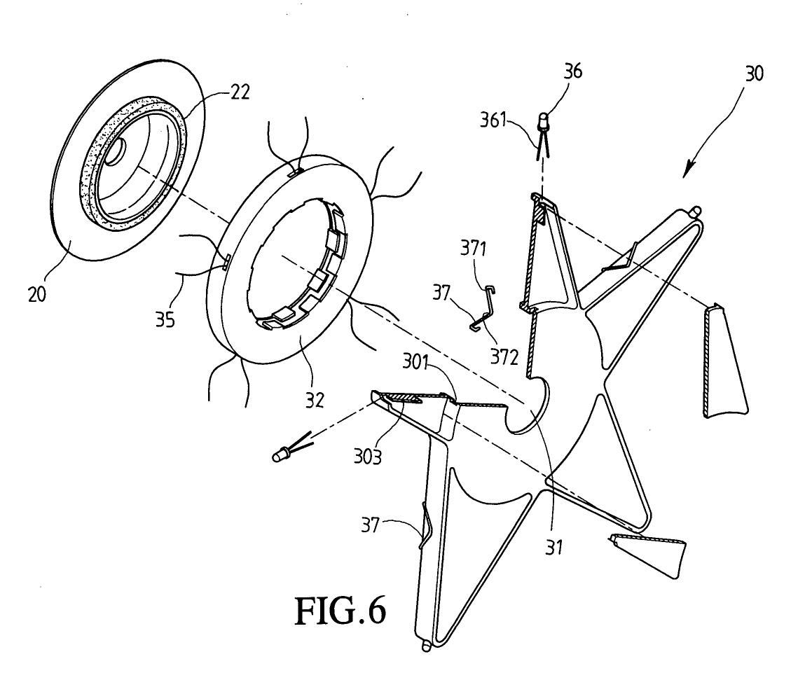

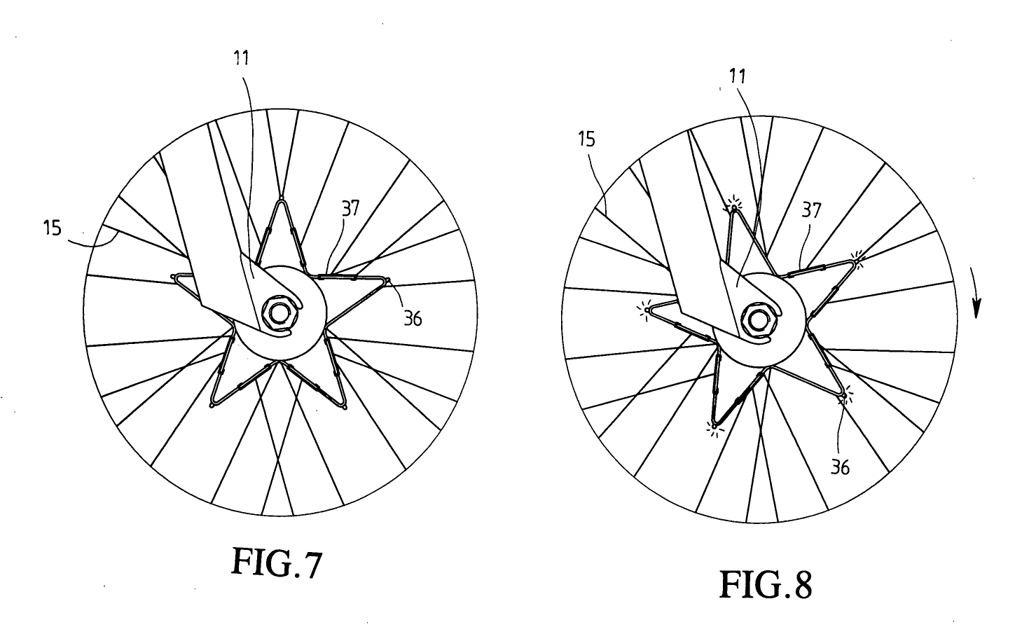

Referring to FIGS. 1 to 6, the illuminating device of the present invention is connected to spokes 15 of a front wheel and/or rear wheel 10, and comprises a casing 30 which can be made as a star as shown in FIGS. 4 and 5 and has a central hole 31 for receiving a wheel axle 12. A plurality of luminous elements 36 are connected to the casing 30. A coil assembly 32 is engaged with a recessed area in a first side of the casing 30 and wires 35 extending from the coil assembly 32 go through holes 301 defined through an inner periphery of the recessed area and are electrically connected to the luminous elements 36 located at tips of the casing 30. The luminous elements 36 are light emitting diodes in this embodiment and each light emitting diodes includes two legs 261 connected respectively to the wires 35. A separation plate 303 extends from an inside of the casing 30 and is located between the two legs 261 of each light emitting diodes so as to prevent the two legs 361 from in contact with each other.

A collar 20 is fixed connected to a front fork 11 or chain stays by mounting a screw 14 and a washer 13 to the wheel axle 12. An circular magnet 22 is engaged with the collar 20 and the wheel axle 12 extends through the circular magnet 22. The coil assembly 32 rotatably encloses the circular magnet 22.

A second side of the casing 30 is a concave side so as to match the spokes 15 and has a plurality of clamping members 37, each of the clamping members 37 has two hooks 371 hooked on the casing 30 and a clamping portion 372 clamping the spokes 15.

The illuminating device of the present invention does not carry a heavy battery and the shape of the casing 30 can be made as desired so as to have decoration feature.

While we have shown and described the embodiment in accordance with the present invention, it should be clear to those skilled in the art that further embodiments may be made without departing from the scope of the present invention.

1. An illuminating device comprising:
a casing having a central hole for being adapted to receive a wheel axle therethrough, a plurality of luminous elements connected to the casing;
a coil assembly engaged with the casing and wires extending from the coil assembly and electrically connected to the luminous elements, and
a collar adapted to be fixed connected to a front fork or chain stays and having an circular magnet, the coil assembly rotatably enclosing the circular magnet.

2. The device as claimed in claim 1, wherein the luminous elements are light emitting diodes and each light emitting diodes includes two legs connected respectively to the wires, a separation plate extending from an inside of the casing and located between the two legs of each light emitting diodes.

3. The device as claimed in claim 1, wherein the casing has a plurality of clamping members which are adapted to connect the spokes.
